(19) United States
(12) Patent Application Publication
(10) Pub. No.: US 2011/0112211 A1
(43) Pub. Date: May 12, 2011

(54) CEMENTING MATERIAL COMPRISING POLYMER PARTICLES, PARTICLES TREATING METHOD AND CEMENT SLURRY

(76) Inventors: Annie Audibert, Croissysur-Seine (FR); Eric Lecolier, Chaville (FR); Alain Rivereau, Rueil-Malmaison (FR); Bertrand Guichard, VIllecresnes (FR); Patrick Vongphouthone, Sceaux (FR)

(21) Appl. No.: 11/816,176

(22) PCT Filed: Feb. 13, 2006
(86) PCT No.: PCT/FR06/00316

§ 371 Date: Jan. 27, 2011

(30) Foreign Application Priority Data
Feb. 14, 2005 (FR) 0501477

(51) Int. Cl. C09K 8/44

(52) U.S. Cl. 523/130

(57) ABSTRACT

The invention relates to a cementing material, to a production method and to a cement slurry comprising polymer particles coated with at least one powdered mineral additive.

### FIELD OF THE INVENTION

The present invention relates to cementing materials, or additives, used to form cement slurry formulations, and to a method allowing these materials to be obtained. The use in cements of polymer particles according to the present invention allows in particular to obtain cement grouts of low density and/or cements having optimized mechanical properties, together with a low permeability.

### BACKGROUND OF THE INVENTION

Borehole and in particular oil well cementing is a complex operation with multiple goals: mechanically secure the casings in the geologic formation, isolate a producing layer from adjacent layers, protect pipes against the corrosion due to the fluids contained in the layers crossed through. The cement sheaths must therefore have good mechanical strengths and a low permeability to the fluids and gases contained in the formations.

The most important part of primary cementing of hydrocarbon production wells is to prevent any fluid (gas, brine, crude, . . . ) motion between the various geologic horizons throughout the life of the well, and also after shut-in. The cemented annulus therefore has to be perfectly sealed, notably against gases. Circulation of the fluids in the annulus can therefore occur along three paths only: the fluids can circulate thanks to the connected porosity (permeability) of the cement matrix, and/or circulate between the cement/casing interface, and/or between the cement/formation interface. In order to reach perfect sealing, several conditions must be met:

annulus filling: the drilling mud has to be completely displaced to prevent any contamination of the cement grout by the drilling fluid left in place and to allow good adhesion of the cement on the casing or the formation,

filter cake removal: a deposit (cake) forms on the wall as a result of mud filtration on the wall. Therefore, if the cake is not removed, or if it is badly removed, the result is poor adhesion of the cement on the formation. Furthermore, under the influence of the cement, this cake can change, thus creating a micro-annulus and, consequently, a sealing defect. The external cake of the drilling fluid therefore has to be removed. The internal cake is not harmful to adhesion, it may however modify the cement grout filtration,

contraction control: too great a contraction of the cement used for cementing the well annulus leads to the formation of micro-annuli at the interfaces,

low cement permeability: the permeability of cements, which is an intrinsic property of these materials, must be as low as possible to prevent any reservoir fluid upflow to the surface and to guarantee good durability,

optimization of the mechanical characteristics of cements so as to prevent breakage of the cement sheath, or separation thereof from the formation or from the casing, under the effect of the pressure or temperature variations during the different stages of the life of a well: drilling, completion, production, stimulation and abandonment.

It has been shown in various publications that the materials used for wellbore cementing should be deformable so as to adjust to the stress variations in the casing without cracking. A criterion has been defined (Thiercelin et al. in the SPE 38598 publication) to prevent tension failure of a cemented annulus. The cement flexibility criterion is defined as the ratio of the tension failure strength Rₜ to Young's modulus Eₜ. To prevent mechanical damage to the cemented annulus, it is well known to favour cements with the highest possible flexibility criterion.

Planning more and more complex wellbores (greatly deflected wells, multidrain wells, . . . ) in increasingly severe environments (HP/HT, deep offshore, acid gas, . . . ) increases recurrent problems that are conventionally encountered during drilling. The sealing loss of cemented annuli is one of the problems the trade is faced with. Sealing loss can notably be due to mechanical failure of the cement sheath if the mechanical properties of the cementing material used are not really suitable.

### SUMMARY OF THE INVENTION

The present invention thus relates to a cementing material comprising polymer particles coated with at least one powdered mineral additive.

The mineral additive can be selected from among the following group: silica, silicates, clay, gypsum, alumina, aluminium oxides, magnesium oxides, calcium oxides, titanium dioxide, talc or equivalent, limy powders, fly ashes, ground blast furnace slag, silica fumes, hydraulic binders or mixtures thereof.

The polymer particles can consist of homopolymer, copolymer, terpolymer or combinations thereof.

The polymer particles can be prepared according to at least one of the following techniques: mass, emulsion, suspension, (anionic, cationic, radical, controlled radical) solution polymerization, polycondensation. Batch, semi-continuous and continuous polymerization processes are suited for preparation of these polymers.

The polymer particles can consist of monomers selected from the following group: styrene, substituted styrene, alkyl acrylate, substituted alkyl acrylate, alkyl methacryls, substituted alkyl methacryls, acrylonitrile, methacrylonitrile, acrylamide, methacrylamide, N-alkyl acrylamide, N-alkyl methacrylamide, isoprene, butadiene, ethylene, vinyl acetate, versatic acid vinyl ester (C9 to C19), and any combination of these monomers.

The polymer particles can consist of functionalized monomers selected from the following group: α-methyl styrene, para-methyl styrene, para-tertbutyl styrene, vinyl toluene, (M)ethyl (Me)acrylate, 2-ethylhexyl (Me)acrylate, butyl (Me)acrylate, (Me)acrylatecyclohexyl, isobornyl (Me)acrylate, isobutyl (Me)acrylate, (Me)acrylate, para-tertbutyl-cyclohexyl, butadiene, isoprene, ethylene, vinyl acetate, (Me)acrylic acid, hydroxyethyl (Me)acrylate, glycidyl methacrylate, sodium benzene sulfonate, and any combination of these monomers.

The amount of mineral additive for coating the polymer particles can range between 0.1 and 50% of the total mass of the polymer particles and mineral additive, preferably between 0.5 and 10%.

The invention also relates to a method of producing a cementing material, wherein polymer particles are coated with at least one powdered mineral additive.

The polymer particles can be coated by mixing and/or crushing with the powdered mineral additive.

It is possible to coat the polymer particles obtained by synthesis in emulsion, suspension or solution with at least one powdered mineral additive added to the polymer dispersion just before the drying stage.

The invention further relates to a cement slurry comprising at least one hydraulic binder, possibly a mineral filler, water, a chemically inert feed of polymer particles coated with at least one powdered mineral additive according to the above description.

The hydraulic binder of the cement slurry can be selected from the following group: a Portland cement, high-alumina cement, sulfoalumina cement, plaster, or a shrewd and functional combination of these binders.

The granular mixtures of cement slurry can be monomodal or multimodal, for example bimodal, trimodal or tetramodal.

The cement slurry can also comprise at least one cement setting and hardening control additive, thinning agents, dispersants, filtrate reducers, anti-gas migration agents, foaming or anti-foaming agents. These examples of additives are in no way limitative.

The present invention describes polymer particles useful for either formulation of lightened cement slurries, i.e. whose density is below 1.9 g/cm³, or formulation of cements with excellent mechanical properties (increase of the tensile strength, ductility, . . . ). According to the invention, the polymer particles are precoated or compatibilized with mineral particles, or mineral additive, notably to contribute towards their dispersion in a cement paste and more generally in a water-base grout. Thus, grouts containing polymer particles coated with mineral particles have better rheological properties than grouts containing the same polymer particles without coating. A cement of low permeability is thus obtained.

The organic particles are polymer matrix particles. According to the invention, the polymers used in cementing materials can be selected from at least one of the groups consisting of linear polymers, graft polymers, branched polymers and network polymers.

According to the invention, a large variety of polymers, or copolymers, can be used to formulate the cementing materials according to the present invention.

According to the present invention, the polymer particles are precoated with a coating agent. The coating agent facilitates dispersion of the polymer and its incorporation to a cement slurry. The polymer particle coating agent consists of mineral particles. The particles of the coating agent are located at the surface of the polymer particles. The interactions between the mineral particles and the polymer can be a priori ionic strong interactions because of the presence of residual surfactant from the synthesis. The mineral particles can be silica, silicates, clays (such as smectites, sepiolite, kaolin, attapulgite), gypsum, alumina, aluminium oxides, magnesium oxides, calcium oxides, titanium dioxide, talc or equivalents, hydraulic binders (such as, for example, Portland cement, high-alumina cements, sulfoalumina cements). A combination of these various minerals is also possible. When the coating agent used is made up of silica, it can be colloidal silica particles or silica fumes.

In the invention, the mineral agent for coating polymer particles can also be one of the following four additives:

limy addition in form of finely divided dry products, obtained by crushing for example. Limy additions come from limy rock deposits that can be dolomitic, massive or unconsolidated rocks,

fly ashes that are fine powders mainly consisting of spherical vitrous particles. These ashes derive from the combustion of coal. They essentially consist of SiO₂ and Al₂O₃,

blast furnace slag from vitrified and ground slurry. It is a co-product of the manufacture of cast iron and it is obtained by hardening of the molten blast furnace slag,

silica fumes are a finely divided amorphous powder resulting from the production of silicon alloys. The amorphous powder made up of very fine particles or of clusters of such particles is carried along with the gas from the combustion zone of furnaces to the collecting zone.

Several paths (or combinations thereof) can be followed for incorporation of the mineral additive to the polymer during the finishing stage. The mineral additive can be either added to the polymer latex, or dispersion, when synthesis in emulsion has been used to synthesize the polymer, or added to the polymer powder. When the mineral additive is added to the polymer powder, coating can be carried out either by mixing and/or by crushing. In all the aforementioned methods used for coating, the coated polymer particles come in form of polymer particles with mineral particles at the surface thereof. The ratio of the diameter of the particles used for coating to the diameter of the polymer particles must be below 0.5, preferably below 0.1.

The amount of mineral additive is preferably selected in such a way that the mass ratio between the mineral additive and the granular mixture consisting of the mineral particles and of the polymer particles ranges between 0.1 and 50%, preferably between 0.5 and 20%, and more specially between 0.5 and 10%. However, an excessive amount of mineral additives can have the drawback of decreasing polymer performances in cements.

One of the advantages of the invention lies in the control of the size of the polymer particles coated or compatibilized with mineral additives. According to the method used to produce the polymer powder, the median diameter (D50) of the coated polymer particles can be selected and range between 0.1 and 2000 micrometers, preferably between 1 and 500 micrometers. The grain-size distribution of the polymer particles can be either monomodal or multimodal. Control of the size and of the grain-size distribution resulting from the production method represents a considerable advantage for the formulation of cement slurries based on piles of particles of different sizes.

### BRIEF DESCRIPTION OF THE FIGURE

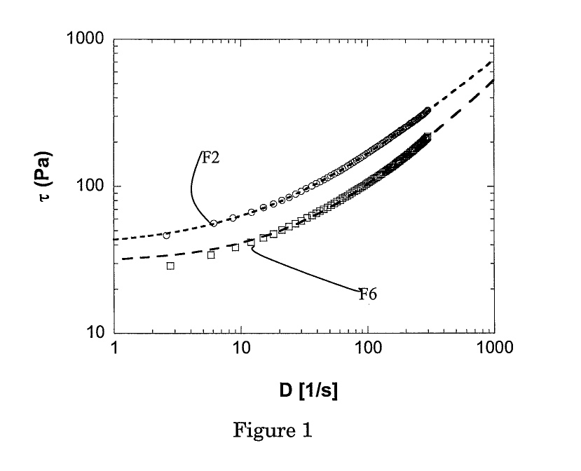

Other features and advantages of the invention will be clear from reading the examples hereafter, illustrated by the sole FIG. 1 that shows a comparison between the rheology of a slurry comprising non-coated polymer particles with a slurry comprising coated particles.

### DETAILED DESCRIPTION

The formulations tested that show the various advantages of the invention are described in Table 1 hereafter. Formulations F1, F2, F3, F4, F5, F6, F13 and F14 contain styrene-acrylate copolymer particles, for example the VASA particles described in document EP-1,195,362. Polymer P8 is the coated version of polymers P1 and P2. Polymers P13, P14, P15 and P16 are different coated versions of polymer P12. Products P13, P14, P15 and P16 differ by the nature of the coating particles and the concentration of the coating mineral particles. Formulations F13, F14, F15 and F16 are cement slurries that combine two particle sizes (cement grains and polymer particles). Formulations F1, F2, F3, F4, F5, F6, F7, F8, F9, F10, F11 and F12 comprise, in relation to formulations F13, F14, F15 and F16, particles of very small size by comparison with that of the cement grains and that of the polymer particles. These particles of very small size can be silica fume or fly ash particles for example. Formulations F1, F2, F3, F4, F5, F6, F7, F8, F9, F10, F11 and F12 thus are formulations combining three particle sizes.

| Formu- | | | | | | | | | | | | | | | | | Thin- | Fil- | | |
|---|---|---|---|---|---|---|---|---|---|---|---|---|---|---|---|---|---|---|---|---|
| lation | Ce- | Ben- | Crushed | Micro- | | | | | | | | | | | | | ning | trate | Den- | |
| name | ment | tonite | sand | silica | P1 | P2 | P5 | P6 | P7 | P8 | P11 | P12 | P13 | P14 | P15 | P16 | agent | reducer | sity | E/C |
| F0 | 100 | 2 | — | — | — | — | — | — | — | — | — | — | — | — | — | — | — | — | 1.66 | 0.73 |
| F1 | 100 | — | 15 | 15 | 35 | — | — | — | — | — | — | — | — | — | — | — | 1.8 | 1 | 1.65 | 0.45 |
| F2 | 100 | — | 15 | 15 | — | 35 | — | — | — | — | — | — | — | — | — | — | 1.8 | 1 | 1.67 | 0.45 |
| F3 | 100 | — | 15 | 15 | | | 35 | | | | | | | | | | 1.8 | 1 | 1.56 | 0.45 |
| F4 | 100 | — | 15 | 15 | | | | 35 | | | | | | | | | 1.8 | 1 | 1.60 | 0.45 |
| F5 | 100 | — | 15 | 15 | | | | | 35 | | | | | | | | 1.8 | 1 | 1.50 | 0.45 |
| F6 | 100 | — | 15 | 15 | | | | | | 35 | | | | | | | 1.8 | 1 | 1.56 | 0.45 |
| F7 | 100 | — | 15 | 15 | | | | | | | 35 | | | | | | 1.8 | 1 | 1.61 | 0.45 |
| F8 | 100 | — | 15 | 15 | | | | | | | | 35 | | | | | 1.8 | 1 | 1.60 | 0.45 |
| F9 | 100 | — | 15 | 15 | | | | | | | | | 35 | | | | 1.8 | 1 | 1.65 | 0.45 |
| F10 | 100 | — | 15 | 15 | | | | | | | | | | 35 | | | 1.8 | 1 | 1.62 | 0.45 |
| F11 | 100 | — | 15 | 15 | | | | | | | | | | | 35 | | 1.8 | 1 | 1.66 | 0.45 |
| F12 | 100 | — | 15 | 15 | | | | | | | | | | | | 35 | 1.8 | 1 | 1.65 | 0.45 |
| F13 | 100 | — | — | 10 | — | 22.8 | — | — | — | — | — | — | — | — | — | — | 0.5 | — | 1.75 | 0.4 |
| F14 | 100 | — | — | 10 | — | — | — | — | — | 22.8 | — | | — | — | — | — | 0.5 | — | 1.74 | 0.4 |
| F15 | 100 | — | — | 10 | — | — | — | — | — | | — | 22.8 | — | — | — | — | 0.5 | — | 1.78 | 0.4 |
| F16 | 100 | — | — | 10 | | | | | | | | | 22.8 | | | | 0.5 | — | 1.80 | 0.4 |

### Example 1

### Examples of Sizes and Grain-Size Distributions Obtained for the Polymer Particles Used According to the Invention

| | Specific | | | | |
|---|---|---|---|---|---|
| | surface | Distribution | | Distribution peaks | |
| Polymer | (m²/g) | form | D50 (μm) | diameter (μm) | |
| P5 | 1.034 | Bimodal | 13.8 | 1.5 | 20 |
| P6 | 0.066 | Monomodal | 160.8 | — | — |
| P7 | 0.060 | Monomodal | 207.3 | — | — |
| P8 | 0.132 | Monomodal | 143.9 | — | — |
| P11 | 0.530 | Monomodal | 40.8 | — | — |
| P12 | 0.055 | Monomodal | 218 | — | — |
| P13 | 0.029 | Monomodal | 297 | — | — |

### Example 2

### Effect of the Coating of the Styrene-Acrylate Polymer Particles on the Mechanical Properties of the Cements Formulated from the Polymers According to the Invention and Containing Three Particle Sizes

Particles P8 are the polymer particles P1 coated with silica fumes (the mass ratio is 2%). Comparison of the results obtained on formulations F1 and F2 thus allows to show the effect of the coating of the polymer particles with a mineral additive. These formulations are compared with a conventional cement of same density called F0.

Curing of the various formulations was carried out at 60° C. in water for 7 days. The results of the mechanical properties of the above formulations are as follows:

| Formulation | R_{c} (MPa) | R_{f} (MPa) | E_{f} (MPa) | R_{f}/E_{f} (×10³) |
|---|---|---|---|---|
| F0 | 10 | 2.63 | 3324 | 0.79 |
| F1 | 28.5 | 9.8 | 5220 | 1.88 |
| F2 | 42.7 | 7.9 | 4372 | 1.81 |

It can be observed that the material formulated from the polymer particles coated with a mineral additive has better mechanical properties. The mineral additive used for coating is a silica fume whose grain-size distribution ranges between 0.1 and 30 μm, and the specific surface is of the order of 18 m²/g. The proportion of additive used is 2% by mass of the total mass of polymer particles and mineral additive. In the case of the formulations containing the polymer particles, the compressive strength is four times as high as for reference formulation F0 of same density as formulations F1 and F2. It can also be seen that the compressive strength is very clearly higher in the case of formulation F2. Furthermore, formulation F2 containing coated polymer particles has a flexibility criterion of the same order of magnitude as that of formulation F1. The flexibility criterion is the ratio of Young's modulus in flexure to the breaking strength in flexure. The flexibility criteria of formulations F1 and F2 are 1,88×10⁻³ and 1,81×10⁻³ respectively. In both cases, the flexibility criterion of formulations F1 and F2 that contain polymer particles is greater than the flexibility criterion of reference formulation F0.

Thus, coating of the polymer particles allows to formulate cementing materials with higher compressive strengths while maintaining a good flexibility of the solid matrix when it is subjected to stresses, notably tensile stresses.

### Example 3

### Effect of the Coating of the Styrene-Acrylate and Styrene-Butadiene Polymer Particles on the Mechanical Properties of the Cements Formulated from the Polymers According to the Invention and Containing Two Particle Sizes

Curing of the various formulations was carried out at 60° C. in water for 7 days. The results of the mechanical properties of the above formulations are as follows:

| Formulation | R_{c} (MPa) | R_{f} (MPa) | E_{f} (MPa) | R_{f}/E_{f} (×10³) |
|---|---|---|---|---|
| F0 | 10 | 2.63 | 3324 | 0.79 |
| F13 | 63.2 | 8.5 | 12059 | 0.71 |
| F14 | 62.1 | 8.3 | 10575 | 0.79 |
| F15 | 62.8 | 7.4 | 13093 | 0.57 |
| F16 | 68.0 | 9.1 | 10421 | 0.87 |

It can be noted that the materials formulated from polymer particles coated with a mineral additive have better mechanical properties. The mineral additive used for coating is a silica fume whose grain size ranges between 0.1 and 30 μm, and the specific surface is of the order of 18 m²/g. The proportion of additive used is 2% by mass in relation to the total mass of polymer particles and mineral additive. In the case of the formulations containing the polymer particles, the compressive strength is very high compared to the compressive strength of reference formulation F0 of same density as formulations F13, F14, F15 and F16, whose compressive strength is six times as high as that of F0 The compressive strengths of the formulations containing polymers are equivalent, except for the formulation containing coated styrene-butadiene type polymers: the compressive strength of formulation F16 is higher than that measured for formulations F13, F14 and F15. Furthermore, formulation F16 containing coated styrene-butadiene polymer particles has the highest flexibility criterion among the four polymer-containing formulations. Formulation F16 has the highest bending strength. All these observations underline the advantage provided by the use of styrene-butadiene type polymer particles coated with a mineral agent for the formulation of cementing materials. It can also be noted that, for each polymer type, the coated version gives the hardened material the best flexibility criterion: thus, the flexibility criterion of formulation F14 is higher than that of formulation F13, and the flexibility criterion of formulation F16 is higher than that of formulation F15.

Thus, coating of the polymer particles allows to formulate cementing materials of higher compressive strength while maintaining good flexibility of the solid matrix when it is subjected to stresses, notably tensile stresses.

### Example 4

### Effect of Polymer Particles Coating on the Permeability of the Cements Formulated from the Polymers of the Invention

The permeabilities of formulations F1, F2 were measured in a Hassler type cell by applying a differential pressure at the ends of the cylindrical sample and by measuring the resulting water flow rate. The permeability of the materials is calculated from Darcy's law.

| Formulation | Density (g/cm³) | Water permeability (×10⁻²⁰ m²) |
|---|---|---|
| F1 | 1.69 | 8 |
| F6 | 1.56 | 0.5 |

The values obtained for the permeability of the materials formulated from styrene-acrylate copolymers are very low for cement type materials. The permeability of a cement paste of density 1.9 g/cm³ under the same temperature conditions ranges between 100 and 1000×10⁻²⁰ m², which is much higher than the values measured for cements resulting from the formulations containing polymer particles according to the invention. On the other hand, the material formulated with the polymer particles coated with a mineral agent (formulation F6) has a permeability value that is 16 times less than the same material formulated with non-coated polymer particles. This shows that the final material obtained is more homogeneous and that the coated polymer particles are well dispersed within the cement matrix with, consequently, a decrease in the material permeability.

### Example 5

### Effect of the Coating of Styrene-Acrylate Polymer Particles on the Flow Properties of the Cement Slurries Formulated from the Polymers of the Invention and Containing Either Three or Two Particle Sizes

The rheological properties are measured by means of an imposed-deformation rate Haake rheometer. The measuring geometry used is that of grooved coaxial cylinders (to prevent any wall slip problem) with an air gap of 3.5 millimeters. The flow curve obtained is interpreted by fitting the Herschel-Bulkley model to the experimental data. The Herschel-Bulkley model is written as follows:

τ=τₛ+K\dot{γ}ⁿ

where:
τ is the shear stress
τₛ is the yield point of the slurry
K is the consistency index (Pa·sⁿ)
n is the flow index
\dot{γ} is the shearing rate.

The table below compares the results obtained for different formulations containing non-coated styrene-acrylate polymer particles and coated styrene-acrylate polymer particles. FIG. 1 shows the rheograms of the two formulations. It can be seen that, in the case of the formulation containing the polymer particles coated with silica fume, the rheological parameters are better insofar as the yield point and the consistency index are lower.

| | | | | Apparent |
|---|---|---|---|---|
| | | | Consistency | viscosity |
| | Yield point | Flow index | index | at 5 s⁻¹ |
| Formulation | (Pa) | n | (Pa · s⁻ⁿ) | (Pa · s) |
| F2 | 39 | 0.73 | 4.48 | 10.7 |
| F6 | 30 | 0.83 | 1.63 | 7.2 |
| F13 | 7.8 | 0.87 | 0.706 | 2.1 |
| F14 | 2.5 | 0.84 | 1.005 | 1.3 |

FIG. 1 clearly shows the comparison of the rheologies between formulations F2 and F6. By comparing the rheological parameters of formulations F2 and F6, we see that the threshold has been brought down and that the consistency index is divided by a factor 2.7 thanks to the coating.

The same observations can be made for formulations F13 and F14. Coating the polymer particles by means of suitably selected mineral particles allows the rheological properties to be improved. The yield point of formulation F13 is 7.8 Pa whereas it is only 2.5 Pa for the same formulation containing the coated polymer particles.

It is interesting to compare the viscosities with low shear gradients. In this shear range, the rheological properties are controlled by the interparticle interactions and they are therefore characteristic of the dispersion state of the suspensions. A low viscosity level means good dispersion of the particles within the suspension. For the formulations including coated polymer particles, it can be noted that the low-gradient viscosities (5 s⁻¹) are systematically lower than for the formulations containing non-coated particles. The viscosity of the formulations comprising coated polymer particles is at least 1.5 times less than that of the formulations obtained with the non-coated polymer particles. These results confirm that coating of the polymer particles with minerals allows to obtain better dispersion of these particles in the cement slurry and in fine to optimize the rheological properties of the cement slurries formulated with this type of products.

### Example 6

### Effect of the Coating of Styrene-Butadiene Polymer Particles on the Flow Properties of the Cement Slurries Formulated from the Polymers of the Invention and Containing Three Particle Sizes

The rheological properties are measured as described above. The flow curve obtained is interpreted by adjusting the Herschel-Bulkley model to the experimental data.

The table below compares the results obtained with different formulations containing non-coated styrene-butadiene polymer particles and coated styrene-butadiene polymer particles. It can be seen that, in the case of the formulation containing the polymer particles coated with silica fume, the rheological parameters are better insofar as the yield point and the consistency index are lower.

| | | | | Apparent |
|---|---|---|---|---|
| | | | Consistency | viscosity |
| | Yield point | Flow index | index | at 5 s⁻¹ |
| Formulation | (Pa) | n | (Pa · s⁻ⁿ) | (Pa · s) |
| F8 | 31 | 0.73 | 2.572 | 7.9 |
| F9 | 11 | 0.85 | 1.340 | 3.3 |

It is interesting to compare the viscosities with low shear gradients. In this shear range, the rheological properties are controlled by the interparticle interactions and they are therefore characteristic of the dispersion state of the suspensions. A low viscosity level means good dispersion of the particles within the suspension. For the formulations including coated polymer particles, it can be noted that the low-gradient viscosities (5 s⁻¹) are systematically lower than for the formulations containing non-coated particles. The viscosity of the formulations comprising coated polymer particles is at least 1.5 times less than that of the formulations obtained with the non-coated polymer particles. These results confirm that coating of the polymer particles with minerals allows to obtain better dispersion of these particles in the cement slurry and in fine to optimize the rheological properties of the cement slurries formulated with this type of products.

### Example 7

### Effect of the Amount of Agent Coating Polymer Particles on the Flow Properties of the Cement Slurries Formulated from the Polymers of the Invention and Containing Three Particle Sizes

The rheological properties are measured as described above. The flow curve obtained is interpreted by adjusting the Herschel-Bulkley model to the experimental data.

| | | | Consistency |
|---|---|---|---|
| | Yield point | Flow index | index |
| Formulation | (Pa) | n | (Pa · s⁻ⁿ) |
| F8 | 31 | 0.73 | 2.572 |
| F9 | 11 | 0.85 | 1.340 |
| F10 | 20.5 | 0.75 | 2.198 |
| F11 | 18.6 | 0.78 | 2.012 |

The four formulations include the same type of polymer, but it is not coated with a mineral agent, formulation F8, or it is coated with a mineral agent, formulations F9, F10 and F11. The mass ratio between the coating agent and the polymer particles for F9, F10 and F11 is 2%, 1% and 4% respectively. It can be observed that, as soon as the polymer is coated with a mineral agent, the rheological properties of the formulation containing these polymer particles are improved insofar as the yield point and the consistency index of formulations F9, F10 and F11 are lower than those of formulation F8. On the other hand, there seems to be an optimum mass ratio of mineral agent for coating so as to obtain good dispersion of the polymer particles within the slurry and consequently better flow properties. This optimum mass ratio seems to range about 2% if the coating agent is a microsilica. In fact, this proportion allows to obtain the lowest yield point and consistency index values in the case of slurry formulations containing three particle sizes. This optimum mass ratio for coating of the particles is specific to the chemical nature of the coating agent.

### Example 8

### Effect of the Chemical Nature of the Agent Coating Polymer Particles on the Flow Properties of the Cement Slurries Formulated from the Polymers of the Invention and Containing Three Particle Sizes

The rheological properties are measured as described above. The flow curve obtained is interpreted by adjusting the Herschel-Bulkley model to the experimental data.

| | | | Consistency |
|---|---|---|---|
| | Yield point | Flow index | index |
| Formulation | (Pa) | n | (Pa · s⁻ⁿ) |
| F8 | 31 | 0.73 | 2.572 |
| F9 | 11 | 0.85 | 1.340 |
| F12 | 9 | 0.84 | 1.537 |

The three formulations include the same type of polymer, but it is not coated with a mineral agent, formulation F8, or it is coated with a mineral agent of microsilica type, formulation F9, or with a mineral agent consisting of Portland clinker, formulation F12. The mass ratio between the coating agent and the polymer particles for F9 and F12 is set at 2%. It can be noted that, whatever the chemical nature of the mineral agent used for coating the particles, better flow properties are always obtained for the formulations comprising polymer particles coated with a mineral agent. In fact, for formulations F9 and F11, the yield point and the consistency index are lower than those of formulation F8 that contains non-coated polymer particles. It can also be seen that coating of the polymer particles with Portland cement particles allows to formulate cement slurries with rheological properties that are equivalent to those measured on a cement slurry containing polymer particles coated with microsilica.

All these examples tend to show the advantage involved by the use of polymer particles for formulating cementing materials with better flow properties, mechanical strengths and carrying properties than conventional cementing materials. Furthermore, comparison of the various formulations has shown the advantage provided by coating of the polymer particles for their good dispersion in the cement slurries, thus providing optimized rheological and mechanical properties.

Using polymer particles in cement slurries, containing different particle sizes or not, does not hinder in any way the use of additives conventionally used in the trade. These additives can be, for example, thinning agents, setting retarders, setting accelerators, lightening agents, agents intended to improve adhesion of the material to various supports, anti-gas migration agents, anti-foaming agents, foaming agents, filtrate reducers, . . . .

1) A cementing material comprising polymer particles, characterized in that said particles are coated with at least one powdered mineral additive.

2) A material as claimed in claim 1, wherein the mineral additive is selected from among the following group: silica, silicates, clay, gypsum, alumina, aluminium oxides, magnesium oxides, calcium oxides, titanium dioxide, talc or equivalent, limy powders, fly ashes, ground blast furnace slag, silica fumes, hydraulic binders, or mixtures thereof.

3) A material as claimed in claim 1, wherein the polymer particles consist of homopolymer, copolymer, terpolymer, or a combination thereof.

4) A material as claimed in claim 1, wherein the polymer particles are prepared according to at least one of the following techniques: mass, emulsion, suspension, (anionic, cationic, radical, controlled radical) solution polymerization, polycondensation.

5) A material as claimed in claim 1, wherein the polymer particles consist of monomers selected from the following group: styrene, substituted styrene, alkyl acrylate, substituted alkyl acrylate, alkyl methacryls, substituted alkyl methacryls, acrylonitrile, methacrylonitrile, acrylamide, methacrylamide, N-alkyl acrylamide, N-alkyl methacrylamide, isoprene, butadiene, ethylene, vinyl acetate, versatic acid vinyl ester (C9 to C19), and any combination of these monomers.

6) A material as claimed in claim 1, wherein the polymer particles consist of functionalized monomers selected from the following group: α-methyl styrene, para-methyl styrene, para-tertbutyl styrene, vinyl toluene, (M)ethyl (Me)acrylate, 2-ethylhexyl (Me)acrylate, butyl (Me)acrylate, (Me)acrylatecyclohexyl, isobornyl (Me)acrylate, isobutyl (Me)acrylate, (Me)acrylate, para-tertbutyl-cyclohexyl, butadiene, isoprene, ethylene, vinyl acetate, (Me)acrylic acid, hydroxyethyl (Me)acrylate, glycidyl methacrylate, sodium benzene sulfonate, and any combination of these monomers.

7) A material as claimed in claim 1, wherein the amount of mineral additive coating the polymer particles ranges between 0.1 and 50% of the total mass of the polymer particles and of mineral additive, preferably between 0.5 and 10%.

8) A method of producing a cementing material, characterized in that polymer particles are coated with at least one powdered mineral additive.

9) A production method as claimed in claim 8, wherein the polymer particles are coated by mixing and/or crushing with said powdered mineral additive.

10) A production method as claimed in claim 8, comprising coating polymer particles obtained by synthesis in emulsion, suspension or solution with said powdered mineral additive added to the polymer dispersion just before the drying stage.

11) A cement slurry comprising at least one hydraulic binder, at least one mineral filler, water, a chemically inert feed of polymer particles coated with at least one powdered mineral additive as claimed in claim 1.

12) A cement slurry as claimed in claim 11, wherein said hydraulic binder is selected from the following group: a Portland cement, high-alumina cement, sulfoalumina cement, plaster, or a mixture of these binders.

13) A cement slurry as claimed in claim 11, wherein the granular mixtures are monomodal.

14) A cement slurry as claimed in claim 11, wherein the granular mixtures are multimodal, for example bimodal, trimodal or tetramodal.

15) A cement slurry as claimed in claim 11, further comprising at least one cement setting and hardening control additive, thinning agents, dispersants, filtrate reducers, anti-gas migration agents, foaming or anti-foaming agents.
